(19) United States
(12) Patent Application Publication
(10) Pub. No.: US 2015/0360877 A1
(43) Pub. Date: Dec. 17, 2015

(54) SYSTEM FOR LOADING PARCEL AND METHOD THEREOF

(71) Applicant: Electronics and Telecommunications Research Institute, Daejeon (KR)

(72) Inventor: Sang Hoon SHIN, Daejeon (KR)

(21) Appl. No.: 14/658,082

(22) Filed: Mar. 13, 2015

(30) Foreign Application Priority Data
Jun. 12, 2014 (KR) 10-2014-0071553

(51) Int. Cl. B65G 43/08; B65G 47/244; G06K 19/06; G06T 7/00; G06K 9/00; G06K 9/32; B65G 15/00; G06T 7/60

(52) U.S. Cl. CPC B65G 43/08; B65G 15/00; B65G 47/244; G06T 7/602; G06T 7/0042; G06K 9/00624; G06K 9/3258; G06K 19/06028; G06T 2210/12

(57) ABSTRACT

Disclosed is a system for loading a parcel, which loads an object on a loading transportation vehicle through a conveyor belt of a loading unit, including: an image information acquiring unit which acquires image information acquired by photographing the parcel on the conveyor belt; an object recognition unit which measures the size of the object from the image information and calculates a rotation state of the object; and a control unit which controls the speed of the conveyor belt according to the size and the rotation state of the object.

### CROSS-REFERENCE TO RELATED APPLICATIONS

This application claims priority to and the benefit of Korean Patent Application No. 10-2014-0071553 filed in the Korean Intellectual Property Office on Jun. 12, 2014, the entire contents of which are incorporated herein by reference.

### TECHNICAL FIELD

The present invention relates to a system for loading a parcel and a method thereof, and more particularly, to technology associated with a system for loading a parcel, which inputs a parcel into a parcel sorter.

### BACKGROUND ART

In general, in a warehouse of articles including deliveries and parcels, while collected articles are unloaded from a vehicle the articles are sorted for each destination of the same section collected articles and the sorted articles are delivered by each region officer.

Such a system includes a conveyor belt 20 that conveys an article 10, a loading transportation vehicle 30 which loads the article 10 moved on the conveyor belt 20, and a track 40 that moves the loading transportation vehicle 30, as illustrated in FIG. 1.

In this case, when the article 10 is loaded on the loading transportation vehicle 30 from the conveyor belt 20, the article 10 is often askew or incorrectly loaded between the loading transportation vehicles. Therefore, smooth article sorting is difficult.

### SUMMARY OF THE INVENTION

An exemplary embodiment of the present invention has been made in an effort to provide a system for loading a parcel and a method thereof which can accurately load a parcel in a loading transportation vehicle of a parcel sorter in a loading conveyor belt.

An exemplary embodiment of the present invention provides a system for loading a parcel, which loads an object on a loading transportation vehicle through a conveyor belt of a loading unit, including: an image information acquiring unit which acquires image information acquired by photographing the parcel on the conveyor belt; an object recognition unit which measures the size of the object from the image information and calculates a rotation state of the object; and a control unit which controls the speed of the conveyor belt according to the size and the rotation state of the object.

The image information acquiring unit may be a motion camera that acquires image information expressed by 3D point information.

The object recognition unit may include an object size measurement unit which calculates a width, a length, and a height of the object from the image information; and an object rotation state checking unit which calculates an angle at which the object rotates from a reference point.

The object size measurement unit sorts the object from the image information, generates a virtual line at the center of an image, processes a bounding box for an object contacting the virtual line to calculate a width, a length, and a height of the bounding box.

The object rotation state checking unit may calculate a coordinate of an apex for one side of the bounding box and calculates a slope by using a coordinate value of the apex.

The object recognition unit may further include an object information recognition unit which recognizes destination information of the object by recognizing barcode or character information printed on the object.

When a plurality of objects exist on the conveyor belt, the control unit checks whether destinations of the plurality of objects are the same as each other and when the destinations of the plurality of objects are the same as each other, the control unit compares the sum of the sizes of the plurality of objects with the size of one loading transportation vehicle.

The control unit may control the conveyor belt so that the plurality of objects are loaded together on one loading transportation vehicle when the size of the loading transportation vehicle is larger than the sum of the sizes of the plurality of objects.

The control unit may load the plurality of objects on different loading transportation vehicles one by one when the size of the loading transportation vehicle is larger than the sum of the sizes of the plurality of objects.

The control unit may determine a rotation degree of the object according to the rotation state calculated by the object recognition unit, and decrease the speed of the conveyor belt when the size of the object is distorted to be larger than the actual size due to the rotational degree and increase the speed of the conveyor belt when the size of the object is distorted to be smaller than the actual size.

The system may further include a storage unit which stores the size information of the object, the rotation state information of the object, the destination information of the object, and the size information of the loading transportation vehicle.

The system may further include a communication unit which performs communication with a parcel sorter server that sorts and moves the object according to the destination information of the object.

Another exemplary embodiment of the present invention provides a method for loading a parcel, which loads an object on a loading transportation vehicle through a conveyor belt of a loading unit, including: acquiring image information acquired by photographing the parcel image information regarding an object on the conveyor belt of the loading unit; measuring the size of the object from the image information; calculating a rotation state of the object from the image information; and controlling the speed of the conveyor belt of the loading unit according to the size and the rotation state of the object to load the object on a loading transportation vehicle.

The method may further include: recognizing destination information of the object; and transmitting the destination information of the object to a parcel sorter server; and transmitting the destination information of the object to a parcel sorter server.

The acquiring of the image information may include photographing the object on the conveyor belt of the loading unit by using a motion camera; and Converting the photographing information into 3D point information.

The measuring of the size of the object may include: distinguishing the conveyor belt of the loading unit and the object in the 3D point information; generating a virtual line at the center of image information when a plurality of objects is provided; processing a bounding box for an object contacting the virtual line; and calculating a width, a length, and a height around each apex of the bounding box.

The calculating of the rotation state of the object may include: processing the bounding box for the object; calculating an apex coordinate of a horizontal side of the bounding box based on an origin point in the image information; and calculating a slope of the horizontal side from the coordinate value of the apex.

The loading of the object on the loading transportation vehicle may include: checking whether the loading transportation vehicle is empty; checking whether a residual space of the loading transportation vehicle is larger than a second object of the conveyor belt of the loading unit when a first object has already been loaded on the loading transportation vehicle; determining that the object is loadable when the residual space of the loading transportation vehicle is larger than the second object of the conveyor belt of the loading unit and loading the second object on the loading transportation vehicle on which the first object is loaded; and Loading the object after waiting for a subsequent loading transportation vehicle when the residual space of the loading transportation vehicle is smaller than the object of the conveyor belt of the loading unit.

The loading of the object on the loading transportation vehicle may include: determining whether the object rotates; and decreasing the speed of the conveyor belt of the loading unit when it is determined that the size of the object is distorted to be larger than an actual size according to a rotation degree of the object and increasing the speed of the conveyor belt of the loading unit when it is determined that the size of the object is distorted to be smaller larger than the actual size to load the object the loading transportation vehicle.

When the residual space of the loading transportation vehicle is larger than the object of the conveyor belt, it may be determined that the object is loadable and in the loading of the object on the loading transportation vehicle, the object which has already been on the loading transportation vehicle may be moved to the outside of the loading transportation vehicle and a space close to the conveyor belt of the loading unit may be emptied.

According to exemplary embodiments of the present invention, a parcel is efficiently loaded in a parcel sorter to smoothly sort parcels and missorting is decreased to improve an increase in performance of the parcel sorter.

### BRIEF DESCRIPTION OF THE DRAWINGS

FIG. 1 is an exemplary diagram at the time of incorrectly loading a parcel in the related art.

FIG. 2 is a configuration diagram of a system for loading a parcel according to an exemplary embodiment of the present invention.

FIG. 3 is an overall configuration diagram of a parcel sorting system including the system for loading a parcel according to an exemplary embodiment of the present invention.

FIG. 4 is a flowchart illustrating a method for loading a parcel according to an exemplary embodiment of the present invention.

FIG. 5 is a flowchart illustrating a method for measuring the size of a parcel according to another exemplary embodiment of the present invention.

FIG. 6 is an exemplary diagram of an image acquiring unit of FIG. 2.

FIGS. 7A and 7B are exemplary diagrams of image information acquired by the image acquiring unit of FIG. 2.

FIG. 8 is an exemplary diagram for describing the method for measuring the size of the parcel of FIG. 5.

FIG. 9 is an exemplary diagram of processing a bounding box for the parcel of FIG. 5.

FIG. 10 is a flowchart illustrating a method for checking a parcel rotation state according to an exemplary embodiment of the present invention.

FIGS. 11A to 11E are exemplary diagrams for describing a method for calculating a parcel rotation angle.

FIG. 12 is a flowchart of a method for loading a parcel on a loading transportation vehicle depending on the size of the parcel according to an exemplary embodiment of the present invention.

FIG. 13 is an exemplary diagram of loading a plurality of parcels on the loading transportation vehicle depending on the size of the parcel in FIG. 12.

FIG. 14 is a flowchart illustrating a method for loading a parcel by controlling the speed of a conveyor belt depending on a rotational angle of the parcel according to an exemplary embodiment of the present invention.

FIG. 15A is an exemplary diagram when the parcel has a normal rotational angle and FIG. 15B is an exemplary diagram when the parcel has an abnormal rotational angle.

FIG. 16A is an exemplary diagram when the parcel having the abnormal rotational angle of FIG. 15 is abnormally loaded and FIG. 16B is an exemplary diagram when the parcel having the abnormal rotational angle of FIG. 15 is normally loaded.

FIG. 17 is a configuration diagram of a computer system according to an exemplary embodiment of the present invention.

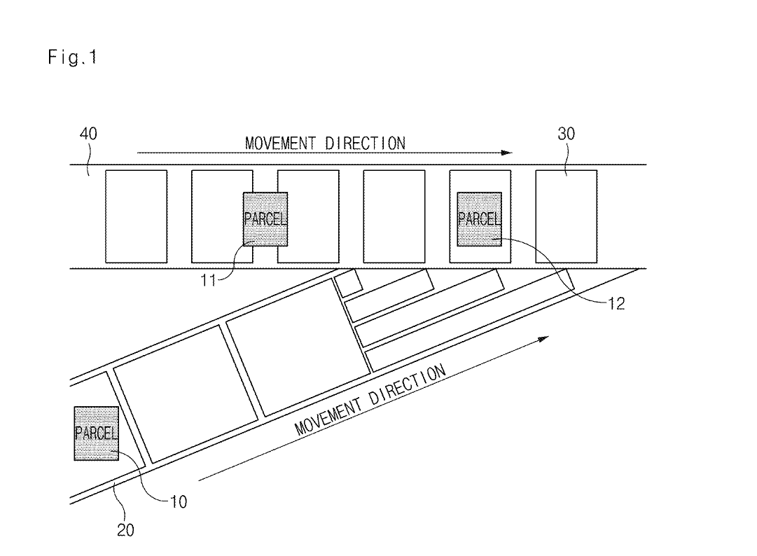

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, for detailed description so as for those skilled in the art to easily carry out the technical spirit of the present invention, exemplary embodiments of the present invention will be described with reference to the accompanying drawings.

The present invention relates to a technology that accurately and efficiently loads a parcel on a loading transportation vehicle of a parcel sorter by sensing the size and a rotational angle of the parcel by using a motion camera for a parcel on a parcel loading conveyor belt.

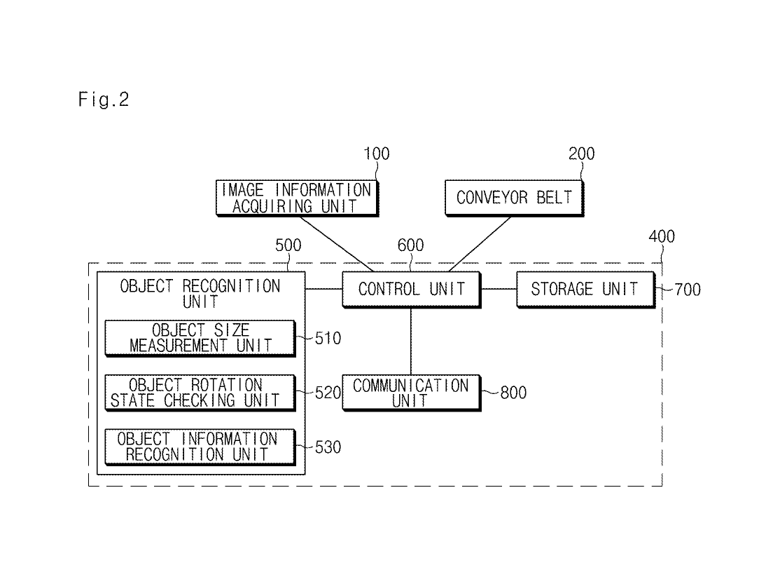

Hereinafter, a system for loading a parcel according to an exemplary embodiment of the present invention will be described with reference to FIGS. 2 to 16.

FIG. 2 is a configuration diagram of a system for loading a parcel according to an exemplary embodiment of the present invention.

The system for loading a parcel according to the exemplary embodiment of the present invention includes an image information acquiring unit 100, a conveyor belt 200, and a loading control server 400.

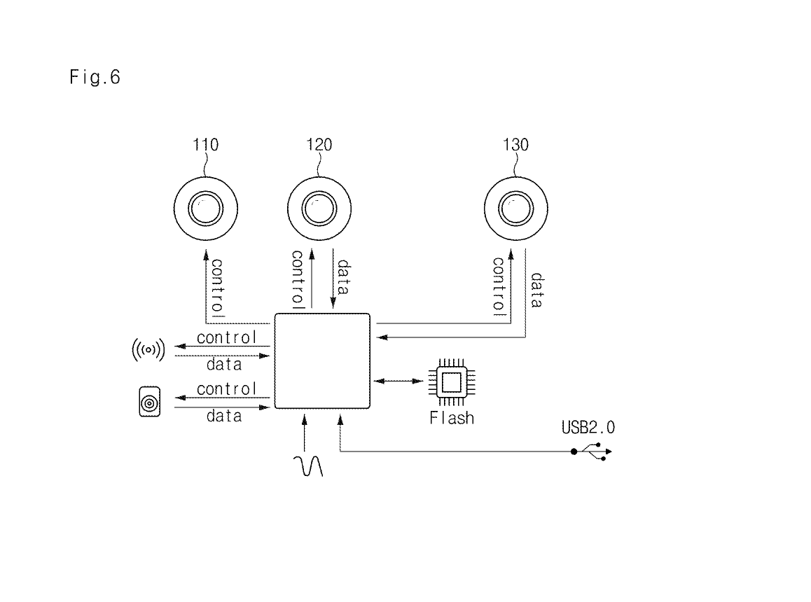

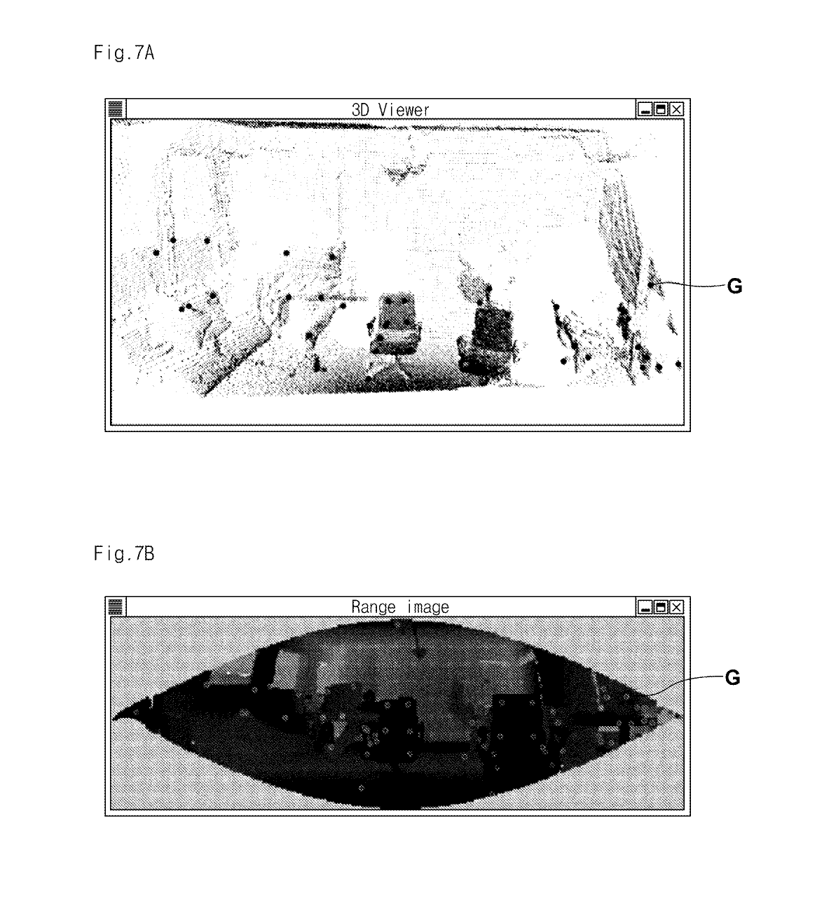

The image information acquiring unit 100 photographs a parcel on the conveyor belt 200 and converts the photographed parcel into 3D point information to provide the corresponding 3D point information to the loading control server 400 and may be implemented by a motion camera. The motion camera includes an IR sensor 110, a depth sensor 120, and a color sensor 130, as illustrated in FIG. 6. The IR sensor 110 may emit infrared rays to calculate a distance per pixel of the infrared rays that are reflected and returned by hitting an obstacle (object) and the depth sensor 120 may provide a 3D image by sensing the position of the object in an image. Further, the color sensor 130 senses a color for the image to provide a color image. Therefore, the motion camera recognizes a motion of the object by using the IR sensor 110 and the depth sensor 120 and expresses the recognized motion as a 3D image. In particular, as illustrated in FIG. 7A, the image is expressed by points of a 3D coordinate and among them, a green circle G represents one obtained by extracting a normal aligned radial feature (NARF) key point to find a contour of the object. In FIG. 7B, a temperature emitted from the object is expressed by a color.

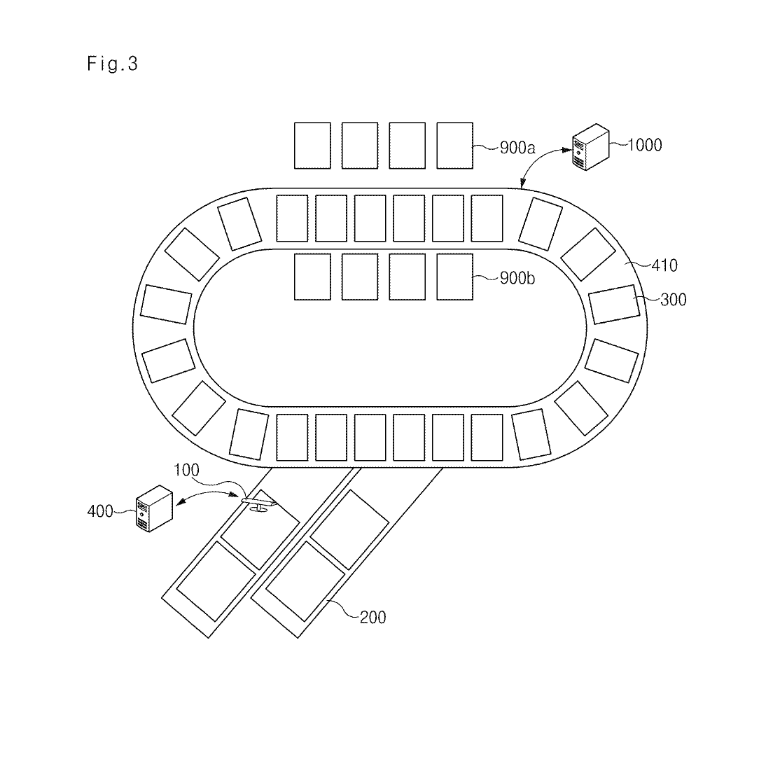

The conveyor belt 200 is controlled by the loading control server 400 to convey the parcel to the loading transportation vehicle 300 (FIG. 3).

The loading control server 400 calculates destination information, the size, and a rotational angle of the parcel by using the image information converted into the 3D point received from the image information acquiring unit 100 and controls the speed of the conveyor belt by using the calculated destination information, size, and rotational angle to load the parcel on the loading transportation vehicle.

To this end, the loading control server 400 includes an object recognition unit 500, a control unit 600, and a storage unit 700, and a communication unit 800.

The object recognition unit 500 calculates the destination information, the size, and the rotational angle of the parcel. To this end, the object recognition unit 500 includes an object size measurement unit 510, an object rotation state checking unit 520, and an object information recognition unit 530.

The object size measurement unit 510 separates only the image of the parcel from the image information acquired from the image acquiring unit 100 and thereafter, and processes a bounding box for the parcel to calculate a width, a length, and a height based on each apex of the bounding box, thereby measuring the size of the parcel. Further, the object size measurement unit 510 compares the calculated width, length, and height of the bounding box with predetermined reference values to calculate an actual size value of the parcel.

In the present invention, since the size is measured by the coordinates of the 3D points, a reference value which is a reference is required. That is, when the size of the bounding box is calculated, the size may be calculated differently depending on the size of the bounding box. Even in the parcels having the same size, the size of the bounding box is calculated largely when the parcel is near and when the size of the bounding box is calculated small and is distant. Therefore, in order to calculate the actual size of the parcel, the size of the parcel is compared with a reference value calculated through learning in advance to calculate the actual size of the parcel. To this end, the object size measurement unit 510 inputs a reference information parcel to perform measurement and learns the actual size value and the 3D point value of the parcel to calculate and store the reference value.

When 3D point information for the conveyor belt is excluded from the 3D point information acquired by expressing all information of the motion camera which is the image acquiring unit 100 by so many points, residual information on the parcel is acquired. In this case, two or more parcels may be recognized and a method that calculates a concentration degree while connecting two points which are most distant from each other from bottom information of the conveyor belt 200 in order to separate two objects to cluster two objects may be used. A scheme of separating the parcel from the image information and a scheme of measuring the size of the parcel are just examples and any various algorithms may be applied to the schemes.

The object rotation state checking unit 520 processes the bounding box (a box covering the object) for the parcel and calculates a slope for a horizontal side of the bounding box to calculate a rotational angle. That is, the object rotation state checking unit 520 is configured to check a rotation degree from an optimal angle for accurately loading the parcel on the loading transportation vehicle 300 and calculates a horizontal or longitudinal rotation degree from an angle at which the parcel may be optimally loaded on the bounding box generated in the object size measurement unit 510. Such a rotational angle calculation method of the parcel is just one example and any various algorithms to calculate the rotational angle from the image information may be applied.

The object information recognition unit 530 recognizes the destination information of the parcel, and the like by recognizing a barcode or a character printed on the parcel. Barcode information or character information determined in this case may be transferred to a parcel sorter server 1000 (FIG. 3) through the communication unit 800.

The control unit 600 controls the speed of the conveyor belt 200 according to the size, the destination information, and the rotation state of the parcel. That is, the control unit 600 may control a plurality of parcels to be together loaded on one loading transportation vehicle when the plurality of parcels have the same destination by using the destination information of the parcel and the sum of the sizes of the parcels does not deviate from the size of the loading transportation vehicle.

The control unit 600 determines the rotation state of the parcel and a size distortion of the parcel by using the rotational angle information calculated in the object rotation state checking unit 520 and controls the speed of the conveyor belt 200 according to the determination result. That is, when the control unit 600 determines that the size of the parcel is distorted to be larger than the actual size, the speed of the conveyor belt 200 is decreased and when the control unit 600 determines that the size of the parcel is distorted to be smaller than the actual size, the speed of the conveyor belt 200 is increased.

The storage unit 700 stores the size, the rotational angle, the destination information, and the like of the parcel calculated by the object recognition unit 500 and stores size information of the loading transportation vehicle, and the like.

The communication unit 800 performs communication with the parcel sorter server 1000 (FIG. 3).

FIG. 3 is an overall configuration diagram of a parcel sorting system including the parcel for loading a parcel according to an exemplary embodiment of the present invention.

The parcels are sorted for each destination by the system for loading a parcel, which has the configuration of FIG. 2 to be loaded on the loading transportation vehicle 300. Thereafter, the loading transportation vehicle 300 moves on the track 410 at a predetermined speed, the parcel is moved up to destination suits 900a and 900b by the loading transportation vehicle 300, and the parcels are differentiated and sorted to a left side 900a or a right side 900b of the loading transportation vehicle according to the destination.

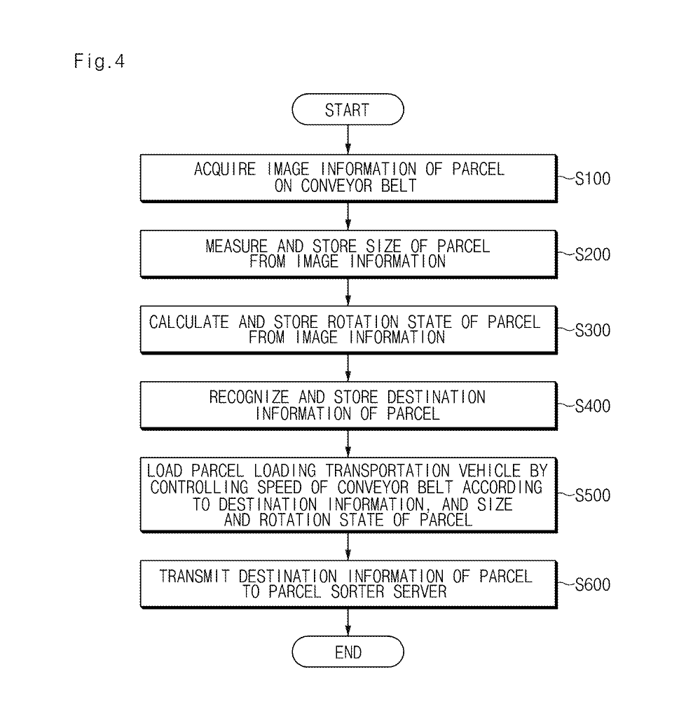

Hereinafter, a method for loading a parcel according to an exemplary embodiment of the present invention will be described with reference to FIG. 4.

First, the image information acquiring unit 100 acquires the image information of the parcel on the conveyor belt (S100). In this case, the image information acquiring unit 100 as the motion camera photographs the parcel on the conveyor belt and converts photographed image information into 3D point information.

Thereafter, the object size measurement unit 510 measures the size of the parcel from the image information converted into the 3D point to store the measured size in the storage unit 700 (S200).

Subsequently, the object rotation state checking unit 520 calculates the rotational angle of the parcel from the image information converted into the 3D point to store the calculated rotational angle in the storage unit 700 (S300).

Thereafter, the object information recognition unit 530 recognizes destination information by recognizing a barcode or a character printed on the parcel and stores the recognized destination information in the storage unit 700 (S400).

Subsequently, the parcel is loaded on the loading transportation vehicle by controlling the speed of the conveyor belt according to the destination information, the size, and the rotation state of the parcel (S500).

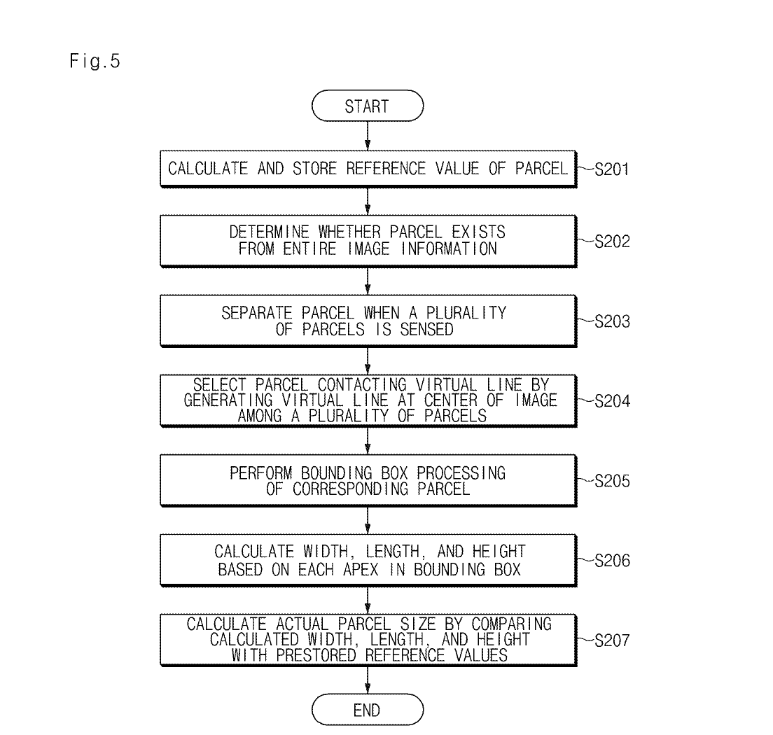

Hereinafter, the method for measuring the size of the parcel of the process S200 of FIG. 4 will be described in detail with reference to FIG. 5.

First, the object size measurement unit 510 inputs a reference information parcel to perform measurement and learns the actual size value and the 3D point value of the parcel to calculate and store the reference value (S201). In the present invention, since the size is measured by the coordinates of the 3D points, a reference value which is a reference is required.

The object size measurement unit 510 excludes 3D point information of the conveyor belt from the image information converted into the 3D point information and separates the 3D point information of the parcel (S202). That is, it is determined whether there is a parcel while the parcel is positioned on the conveyor belt 200 and since most of the conveyor belts 200 are flat and the parcel is expressed as point information having a shape in which the parcel is unevenly projected from a flat plane, the parcel and the conveyor belt 200 may be distinguished.

Thereafter, when a plurality of separated parcels is provided, the object size measurement unit 510 separates the plurality of parcels from each other (S203). In this case, a plane model segmentation algorithm is applied in order to separate the plurality of parcels and this is a scheme in which points are gathered around one plane and if the points are not gathered, the points are recognized as different objects.

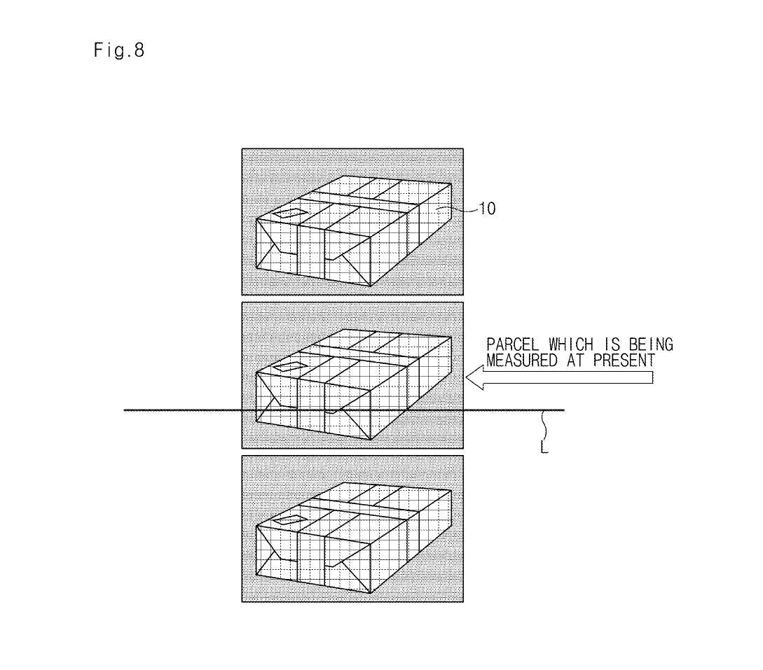

Subsequently, as illustrated in FIG. 8, the object size measurement unit 510 generates a virtual line L at the center of the image among the plurality of parcels 10 and selects a parcel contacting the virtual line among the plurality of parcels (S204).

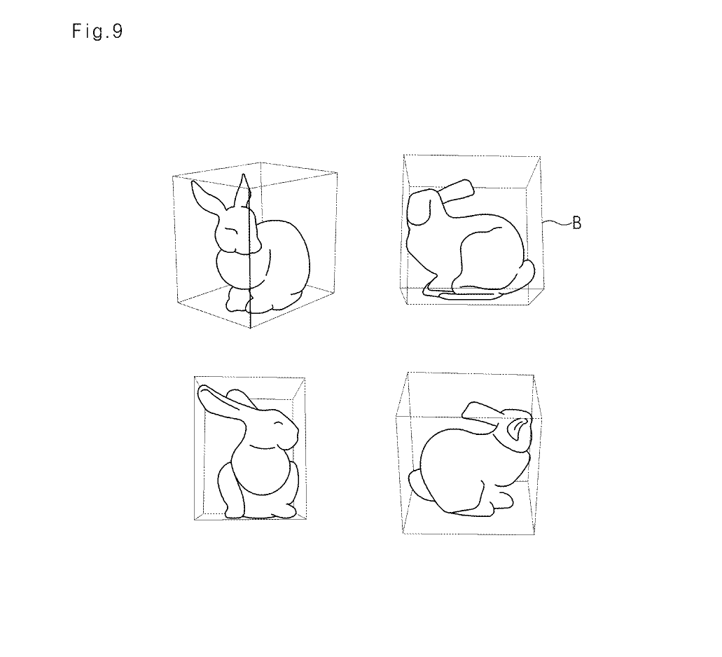

Thereafter, as illustrated in FIG. 9, the object size measurement unit 510 processes the bounding box B for the selected parcel (S205). In this case, the bounding box B is formed in a hexahedral shape to cover the parcel.

Subsequently, the object size measurement unit 510 calculates a width, a length, and a height based on each apex in the bounding box (S206).

Thereafter, the object size measurement unit 510 compares the calculated width, length, and height of the bounding box with predetermined reference values to calculate an actual size value of the parcel (S207). That is, when the size of the bounding box is calculated, the size may be calculated differently depending on the position of the bounding box. Since the size of the bounding box is calculated differently when the parcel is near or when the parcel is distant, the size of the parcel is compared with a reference value calculated through learning in advance to calculate the actual size of the parcel to calculate an actual size of the parcel.

The method for measuring the size of the parcel of the present invention is not limited to the algorithm disclosed in FIG. 5, but the size of the parcel may be measured by applying various schemes.

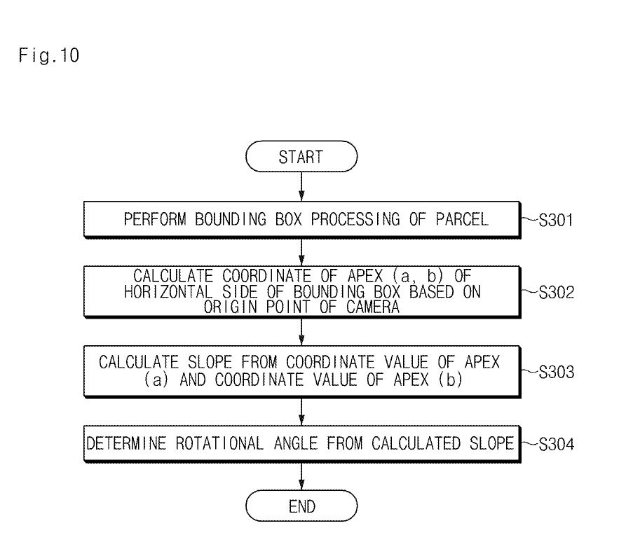

Hereinafter, the method for checking the rotation state of the parcel of the process S300 of FIG. 4 will be described in detail with reference to FIG. 10.

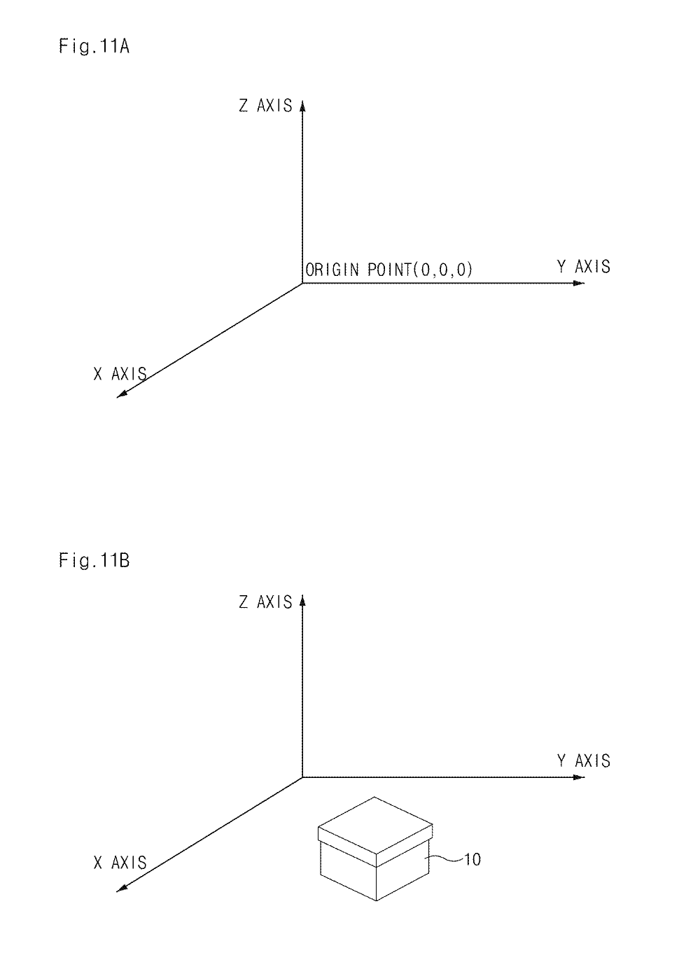

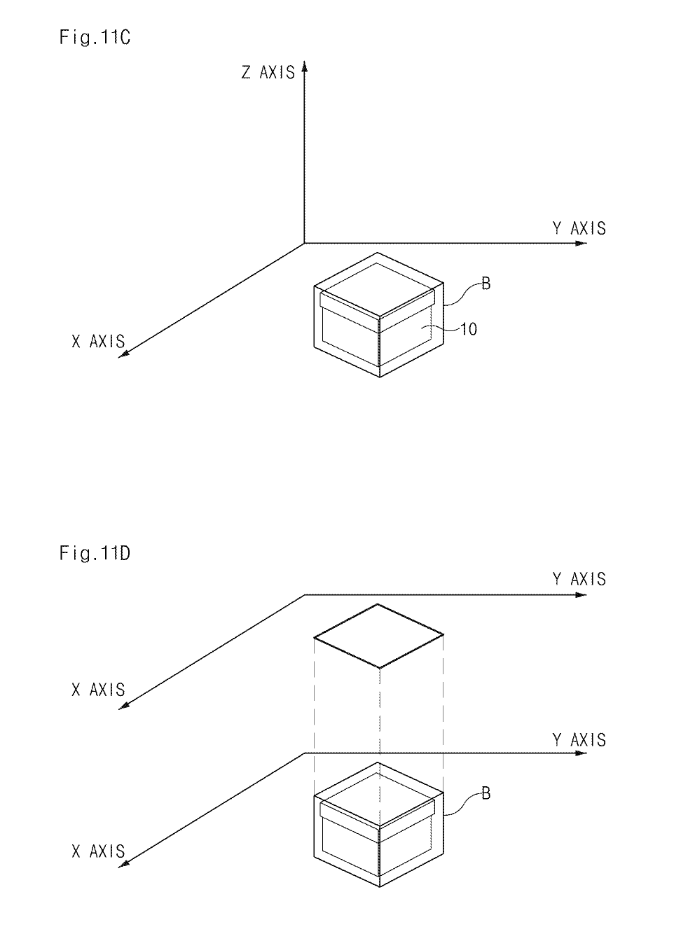

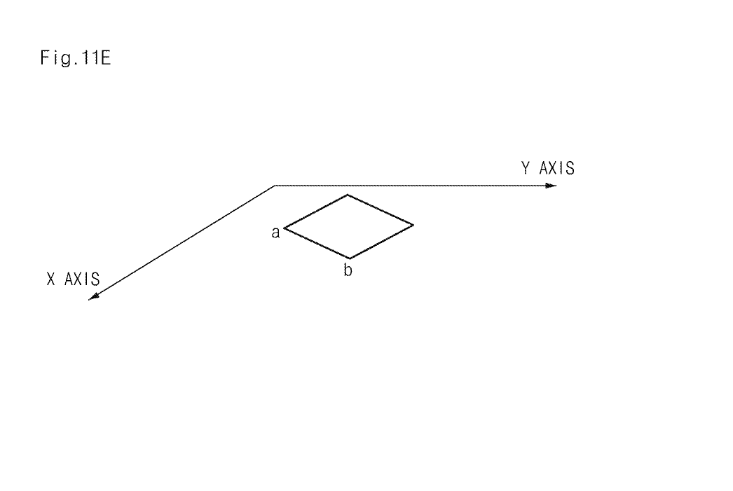

First, the object rotation state checking unit 520 processes the bounding box for the parcel (S301). In this case, as the bounding box, a result processed in the object size measurement unit 510 may be just used. That is, as illustrated in FIG. 11A, it is assumed that a camera origin point (0, 0, 0) exists, and as illustrated in FIG. 11B, the parcel 10 is positioned at a location distant from the origin point by a predetermined distance, and as illustrated in FIG. 11C, it is assumed that the bounding box B for the parcel 10 is processed.

Thereafter, the object rotation state checking unit 520 projects one plane of the bounding box onto an X, Y plane as illustrated in FIG. 11D in order to calculate a rotational angle of the bounding box and calculates each apex (a, b) for one side (a-b) on one plane projected on the X, Y plane as illustrated in FIG. 11E, in order to calculate a rotational angle of the bounding box (S302).

Subsequently, the object rotation state checking unit 520 calculates a slope from a coordinate value (x, y) of an apex a and a coordinate value of a coordinate value (x′, y′) of an apex b as shown in Equation 1 below (S303).

(y′-y)/(x′-x)=slope [Equation 1]

Therefore, the object rotation state checking unit 520 affixes arc tangent to the slope to calculate the rotational angle as shown in Equation 2 below (S304).

Rotational angle=a tan (slope) [Equation 2]

As described above, the rotational angle of the parcel is calculated to determine how large the parcel rotates in normal category. Further, the method for measuring the rotation state of the parcel of the present invention is not limited to the algorithm disclosed in FIG. 10, but the rotation state of the parcel may be measured by applying various schemes.

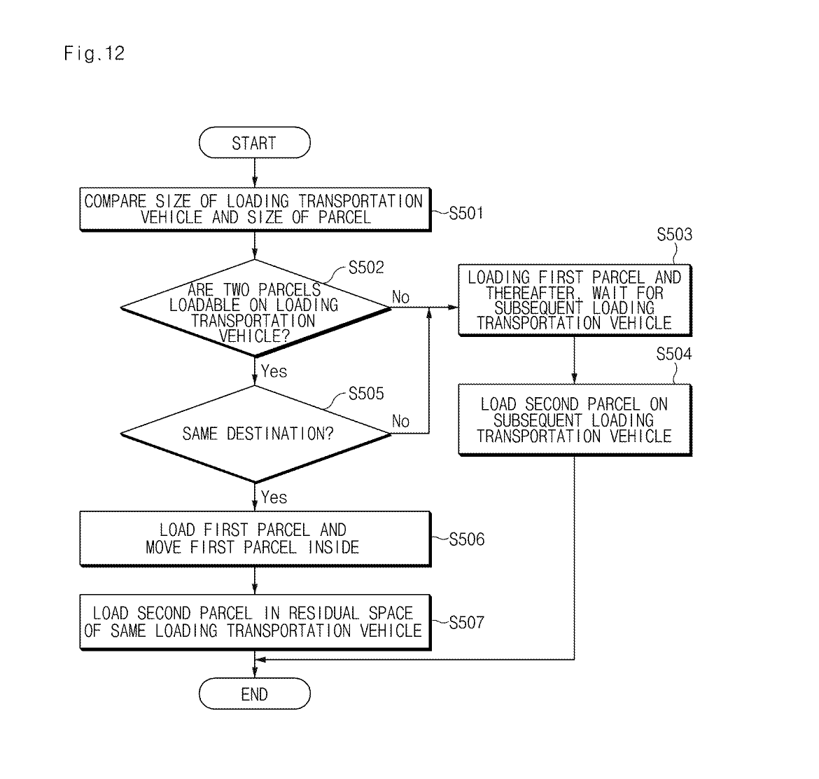

Hereinafter, a method for loading a parcel on a loading transportation vehicle depending on the size of the parcel according to an exemplary embodiment of the present invention will be described with reference to FIG. 12.

First, the control unit 600 compares the size information of the loading transportation vehicle 300 stored in the storage unit 700 and the size information of the parcel calculated by the object size measurement unit 510 (S501). That is, the sum of the sizes of two or more parcels and the size of one loading transportation vehicle are compared with each other.

Therefore, the control unit 600 checks whether two parcels are loadable on the loading transportation vehicle (S502) and when the two parcels may not be loaded, the control unit 600 first loads a first parcel and thereafter, waits for a subsequent loading transportation vehicle (S503) and loads a second parcel (S504). In this case, the control unit 600 controls loading the parcel by controlling the speed of the conveyor belt 200.

Meanwhile, when two parcels may be loaded on the loading transportation vehicle in the process S502, the control unit 600 checks whether destinations of the first parcel and the second parcel are the same as each other by using the destination information recognized by the object information recognition unit 530 (S505).

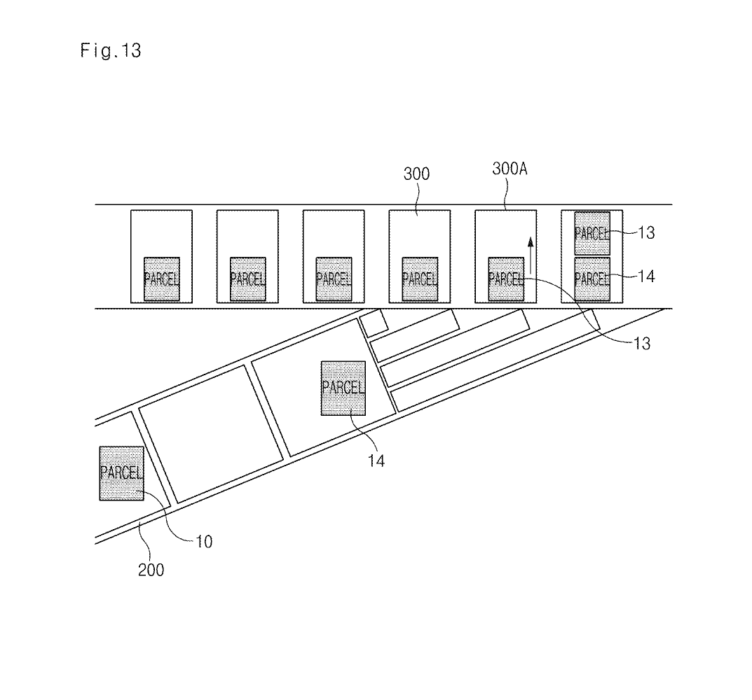

Thereafter, when the destinations of the first parcel and the second parcel are different from each other, the processes S503 and S504 are performed. Meanwhile, when the destinations of the first parcel and the second parcel are the same as each other, the first parcel 13 is first loaded on the loading transportation vehicle 300A and the first parcel 13 is moved to the inside of the loading transportation vehicle as illustrated in FIG. 13 (S506).

Thereafter, the control unit 600 loads the second parcel 14 that waits on the conveyor belt 2000 in an empty space of the same loading transportation vehicle 300A (S507).

In the processes S506 and S507, the control unit 600 controls movement of the track 410 in link with the parcel sorter server 1000 (FIG. 3) that controls the movement of the track 410. That is, the first parcel 13 is loaded and thereafter, the movement of the track 410 is temporarily stopped and thereafter, the second parcel 14 is loaded and thereafter, the track 410 is moved again.

Therefore, in the present invention, even though a parcel which is loaded on the loading transportation vehicle 300 in advance exists, when the size information of the parcel recognized by the object size measurement unit 510 is smaller than a room of the loading transportation vehicle 300, the parcel is enabled to be loaded by adjusting the loading transportation vehicle 300 so as to load the parcel, thereby improving parcel loading efficiency.

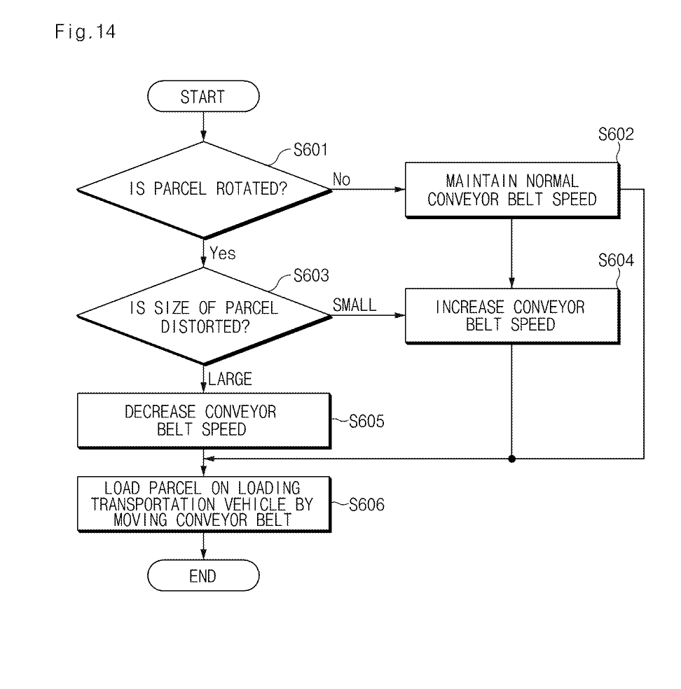

Hereinafter, the method for loading the parcel by controlling the speed of the conveyor belt according to the rotational angle of the parcel according to the exemplary embodiment of the present invention will be described in detail with reference to FIG. 14.

First, the control unit 600 determines whether the parcel rotates at a reference angle or more from the rotational angle information of the parcel calculated by the object rotation state checking unit 520 (S601).

The control unit 600 determines that a rotation degree is small when the parcel rotates at the reference angle or less and controls the conveyor belt to maintain a normal speed (S602).

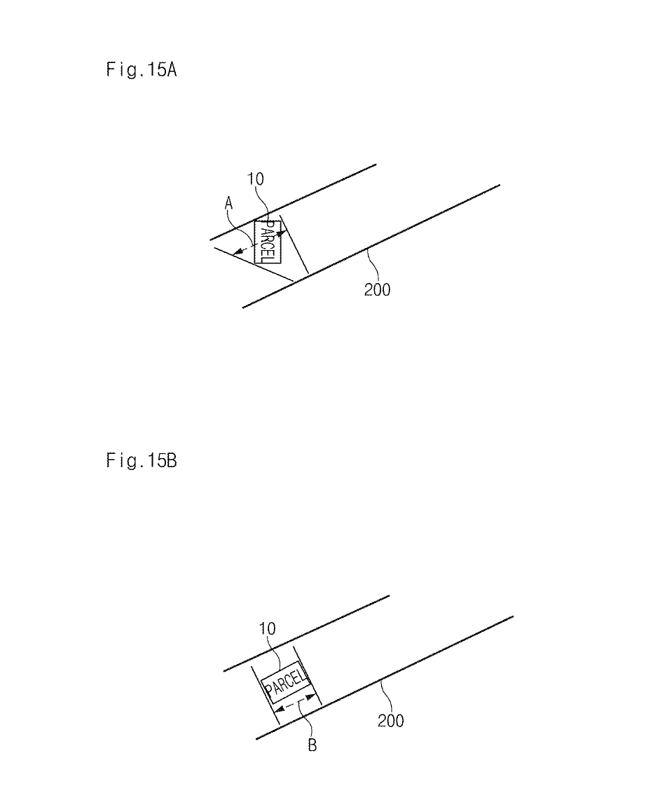

Meanwhile, the control unit 600 determines a distortion degree of the parcel size according to a rotational direction when the parcel rotates out of a reference range. That is, as illustrated in FIG. 15, when the parcel rotates in FIG. 15B as compared with the size A of the parcel in a normal state in FIG. 15A, the size B of the parcel may be determined to be smaller than the size A.

Therefore, the control unit 600 determines the distortion of the parcel size according to the rotational angle and when it is determined that the size of the parcel is distorted to be smaller than the actual size, the control unit 600 increases the speed of the conveyor belt 200 (S604) and when it is determined that the size of the parcel is distorted to be larger than the actual size, the control unit 600 decreases the speed of the conveyor belt 200 (S605).

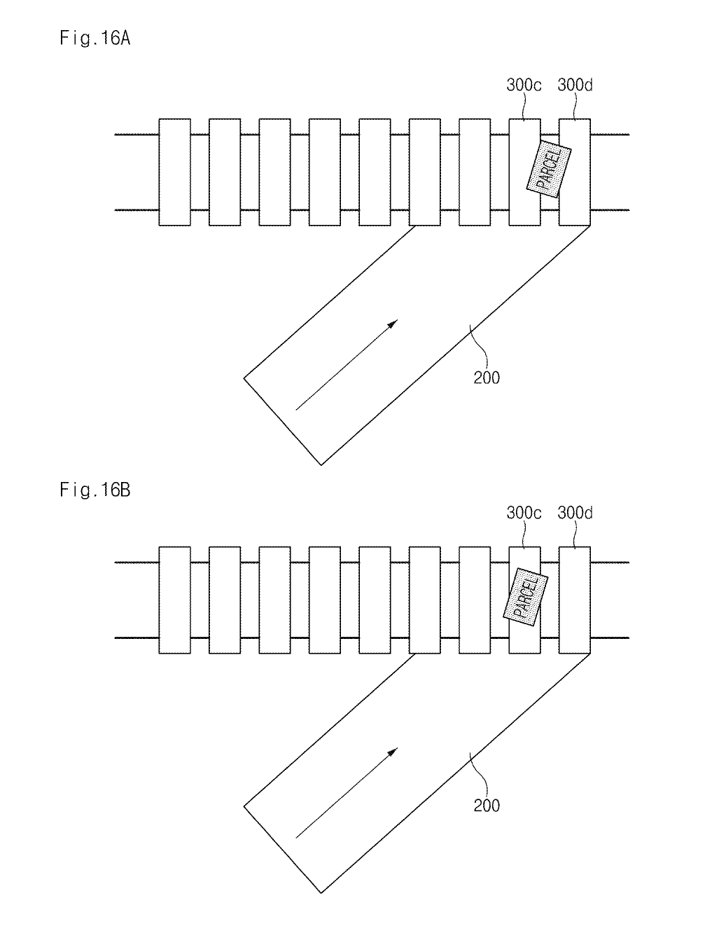

That is, in the case where the parcel is rotated and twisted, when the parcel normally enters, since the parcel is loaded between loading transportation vehicles 300c and 300d as illustrated in FIG. 16A, the control unit 600 controls the parcel to be loaded on the loading transportation vehicle 300c as illustrated in FIG. 16B by decreasing the speed of the conveyor belt 200.

As described above, according to the present invention, the distortion of the size of the parcel is determined according to the rotational angle of the parcel and the speed of the conveyor belt is controlled according to the rotation degree of the parcel, that is, the distortion degree of the size of the parcel to control the parcel to be normally loaded on the loading transportation vehicle.

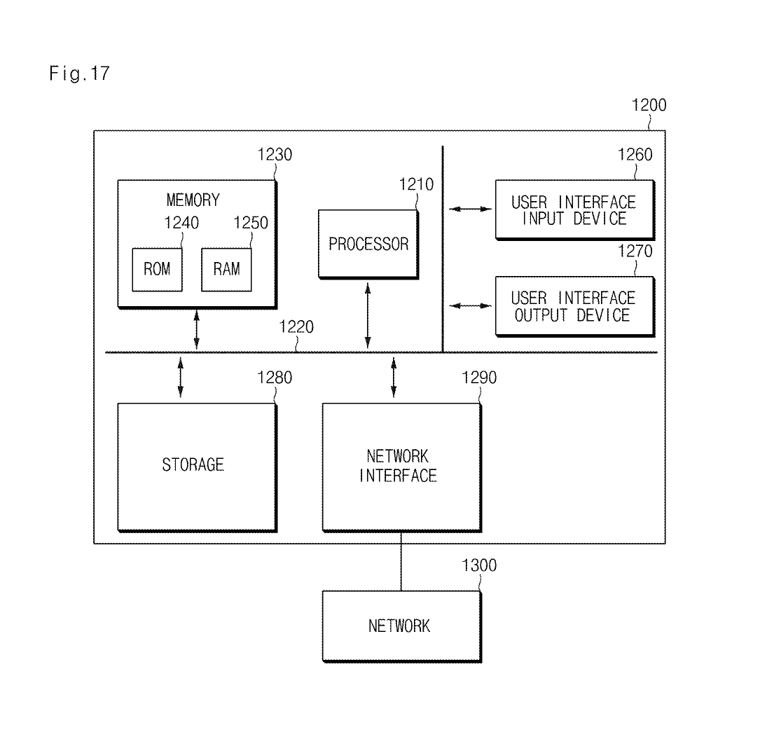

An embodiment of the present invention may be implemented in a computer system, e.g., as a computer readable medium. As shown in in FIG. 17, a computer system 1200 may include one or more of a processor 1210, a memory 1230, a user input device 1260, a user output device 1270, and a storage 1280, each of which communicates through a bus 1220. The computer system 1200 may also include a network interface 1290 that is coupled to a network 1300. The processor 1210 may be a central processing unit (CPU) or a semiconductor device that executes processing instructions stored in the memory 1230 and/or the storage 1280. The memory 1230 and the storage 1128 may include various forms of volatile or non-volatile storage media. For example, the memory may include a read-only memory (ROM) 1240 and a random access memory (RAM) 1250.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

What is claimed is:

1. A system for loading a parcel, which loads an object on a loading transportation vehicle through a conveyor belt of an loading unit, the system comprising:
an image information acquiring unit which acquires image information acquired by photographing the parcel on the conveyor belt;
an object recognition unit which measures the size of the object from the image information and calculates a rotation state of the object; and
a control unit which controls the speed of the conveyor belt according to the size and the rotation state of the object.

2. The system of claim 1, wherein the image information acquiring unit is a motion camera that acquires image information expressed by 3D point information.

3. The system of claim 1, wherein the object recognition unit includes:
an object size measurement unit which calculates a width, a length, and a height of the object from the image information; and
an object rotation state checking unit which calculates an angle at which the object rotates from a reference point.

4. The system of claim 3, wherein the object size measurement unit sorts the object from the image information, generates a virtual line at the center of an image, processes a bounding box for an object contacting the virtual line to calculate a width, a length, and a height of the bounding box, and compares the calculated width, length, and height of the bounding box with a prestored reference value to calculate an actual size of the object.

5. The system of claim 3, wherein the object rotation state checking unit calculates a coordinate of an apex for one side of the bounding box and calculates a slope by using a coordinate value of the apex.

6. The system of claim 3, wherein the object recognition unit further includes an object information recognition unit which recognizes destination information of the object by recognizing barcode or character information printed on the object.

7. The system of claim 6, wherein when a plurality of objects exist on the conveyor belt, the control unit checks whether destinations of the plurality of objects are the same as each other and when the destinations of the plurality of objects are the same as each other, the control unit compares the sum of the sizes of the plurality of objects with the size of one loading transportation vehicle.

8. The system of claim 7, wherein the control unit controls the conveyor belt so that the plurality of objects are loaded together on one loading transportation vehicle when the size of the loading transportation vehicle is larger than the sum of the sizes of the plurality of objects.

9. The system of claim 8, wherein the control unit loads the plurality of objects on different loading transportation vehicles one by one when the size of the loading transportation vehicle is larger than the sum of the sizes of the plurality of objects.

10. The system of claim 1, wherein the control unit determines a rotation degree of the object according to the rotation state calculated by the object recognition unit, and decreases the speed of the conveyor belt when the size of the object is distorted to be larger than the actual size due to the rotational degree and increases the speed of the conveyor belt when the size of the object is distorted to be smaller than the actual size.

11. The system of claim 1, further comprising:
a storage unit which stores the size information of the object, the rotation state information of the object, the destination information of the object, and the size information of the loading transportation vehicle.

12. The system of claim 1, further comprising:
a communication unit which performs communication with a parcel sorter server that sorts and moves the object according to the destination information of the object.

13. A method for loading a parcel, which loads an object on a loading transportation vehicle through a conveyor belt of a loading unit, the method comprising:
acquiring image information acquired by photographing the parcel image information regarding an object on the conveyor belt of the loading unit;
measuring the size of the object from the image information;
calculating a rotation state of the object from the image information; and
controlling the speed of the conveyor belt of the loading unit according to the size and the rotation state of the object to load the object on a loading transportation vehicle.

14. The method of claim 13, further comprising:
recognizing destination information of the object; and
transmitting the destination information of the object to a parcel sorter server.

15. The method of claim 13, wherein the acquiring of the image information includes:
photographing the object on the conveyor belt of the loading unit by using a motion camera; and
converting the photographing information into 3D point information.

16. The method of claim 15, wherein the measuring of the size of the object includes:
distinguishing the conveyor belt of the loading unit and the object in the 3D point information;
generating a virtual line at the center of image information when a plurality of objects is provided;
processing a bounding box for an object contacting the virtual line; and
calculating a width, a length, and a height around each apex of the bounding box.

17. The method of claim 15, wherein the calculating of the rotation state of the object includes:
processing the bounding box for the object;
calculating an apex coordinate of a horizontal side of the bounding box based on an origin point in the image information; and
calculating a slope of the horizontal side from the coordinate value of the apex.

18. The method of claim 13, wherein the loading of the object on the loading transportation vehicle includes:
checking whether the loading transportation vehicle is empty;
checking whether a residual space of the loading transportation vehicle is larger than a second object of the conveyor belt of the loading unit when a first object has already been loaded on the loading transportation vehicle;
determining that the object is loadable when the residual space of the loading transportation vehicle is larger than the second object of the conveyor belt of the loading unit and loading the second object on the loading transportation vehicle on which the first object is loaded; and
loading the object after waiting for a subsequent loading transportation vehicle when the residual space of the loading transportation vehicle is smaller than the object of the conveyor belt of the loading unit.

19. The method of claim 18, wherein the loading of the object on the loading transportation vehicle includes:
determining whether the object rotates; and
decreasing the speed of the conveyor belt of the loading unit when it is determined that the size of the object is distorted to be larger than an actual size according to a rotation degree of the object and increasing the speed of the conveyor belt of the loading unit when it is determined that the size of the object is distorted to be smaller larger than the actual size to load the object the loading transportation vehicle.

20. The method of claim 18, wherein in the loading of the second object, the first object which has already been on the loading transportation vehicle is moved to the outside of the loading transportation vehicle and a space close to the conveyor belt of the loading unit is emptied.
